(19) United States
(12) Patent Application Publication
(10) Pub. No.: US 2026/0321101 A1
(43) Pub. Date: Oct. 15, 2026

(54) VERIFIABLY RANDOM VIRTUAL ROULETTE GAME

(71) Applicant: Matthew Simone, Allendale, NJ (US)

(72) Inventor: Matthew Simone, Allendale, NJ (US)

(21) Appl. No.: 19/175,782

(22) Filed: Apr. 10, 2025

(51) Int. Cl. G07F 17/32

(52) U.S. Cl. CPC G07F 17/3288; G07F 17/3225; G07F 17/3241; G07F 17/3244

(57) ABSTRACT

In this virtual roulette game, the result of each round of play is determined by a “True Random Number Generator” (TRNG), in which the result is derived from a physical source of entropy-which is the scientific standard for true randomness. The verifiably true randomness of this virtual roulette game is assured by its use of “atomic clock” time, as transmitted by the National Institute of Standards and Technology (NIST) in the form of Coordinated Universal Time (UTC)-the state-of-the-art in exactness of time. The virtual roulette display invention features an “atomic” UTC-based clock, which exactly determines the timing of each round of the game and the precise time when the TRNG generates the winning number for each round. An outcome display provides a verification code for the TRNG, as well as the atomic click “time stamp” specifying the exact time when the truly random number was generated. The combination of scientific randomness and scientific timing enables the player, after each round of this virtual roulette game, to verify the fairness of the result with absolute confidence.

### FIELD OF INVENTION

The present invention relates generally to the field of virtual electronic games, and more particularly to virtual casino-type games of chance.

### BACKGROUND OF THE INVENTION

In its physical version, the game of roulette involves a spinning wheel with numbered red/black receiving slots surrounded by a sloping ball track. At the beginning of each round of the game, players make their bets at a betting table by placing chips on specific numbers, colors, odd/even, etc. After betting has stopped, a dealer spins the roulette wheel and launches a small ball onto the ball track. As the ball loses speed, it falls into one of the receiving slots, and the number/color of that slot determines the winning bets.

Even if a physical roulette game is operated honestly, there are issues concerning the fairness and actual randomness of the results. As the wheel wears over time, the random distribution of the ball's path becomes increasingly compromised, and experienced players can use their knowledge of these effects to gain an unfair advantage over other players and the house.

The prior art has attempted to address these issues of randomness and fairness by using a generic random number generator to determine the result of each round of the roulette game either in conjunction with a physical wheel or on a purely virtual electronic basis. The problem with this approach, however, is that the results of conventional random number generators are determined by algorithms or by “random” statistical data, such as financial indicators. Such systems are referred to as “Pseudo-Random Number Generators” (PRNG), because they are actually subject to predictability and manipulation.

Another drawback of the prior art systems is their lack of verifiability. The result of any random number generator depends on the exact time when the generator is queried and the “seed” which is used to initiate the generation process. Unless a roulette system provides verification of both of these factors after each round of the game, it lacks the transparency needed to confirm fairness.

### SUMMARY OF THE INVENTION

The present invention addresses the foregoing deficiencies in the prior art by providing a virtual roulette game in which the result of each round of play is determined by a “True Random Number Generator” (TRNG). TRNG differs from PRNG insofar as the result is derived from a physical source of entropy-which is the scientific standard for true randomness. Such truly random entropy source includes quantum phenomena, such as random emission of photons or decay of radioactive isotopes, as well as thermal entropy in the form of random fluctuations in temperature or electrical signal, and atmospheric entropy.

The second prong of the verifiably true randomness of this virtual roulette game is its use of “atomic clock” time, as transmitted by the National Institute of Standards and Technology (NIST) in the form of Coordinated Universal Time (UTC). This represents the state-of-the-art in exactness of time. The virtual roulette display of the present invention features an “atomic” UTC-based clock which exactly determines the timing of each round of the game and—most importantly—the precise time when the TRNG generates the winning number for each round. That exact time is displayed on the “countdown clock” in the virtual game room and on the “outcome display.” The latter includes a verification code from the TRNG, as well as the atomic clock “time stamp” specifying the exact time when the truly random number was generated.

This combination of scientific randomness and scientific timing enables the player, after each round of this virtual roulette game, to absolutely verify the fairness of the result with absolute confidence. Therefore, the present invention achieves what other “random” roulette games in the prior art fail to achieve—namely, the “provably fair” results which strict standards of casino-type gaming demand.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a schematic drawing of a exemplary central server system and its Internet links to players' electronic devices, according to one embodiment of the present invention;

FIG. 2 is a schematic diagram of an exemplary virtual game room display, according to one embodiment of the present invention; and

FIG. 3 is a flow chart of an exemplary virtual roulette game procedure, according to one embodiment of the present invention.

### DETAILED DESCRIPTION OF THE PREFERRED EMBODIMENT

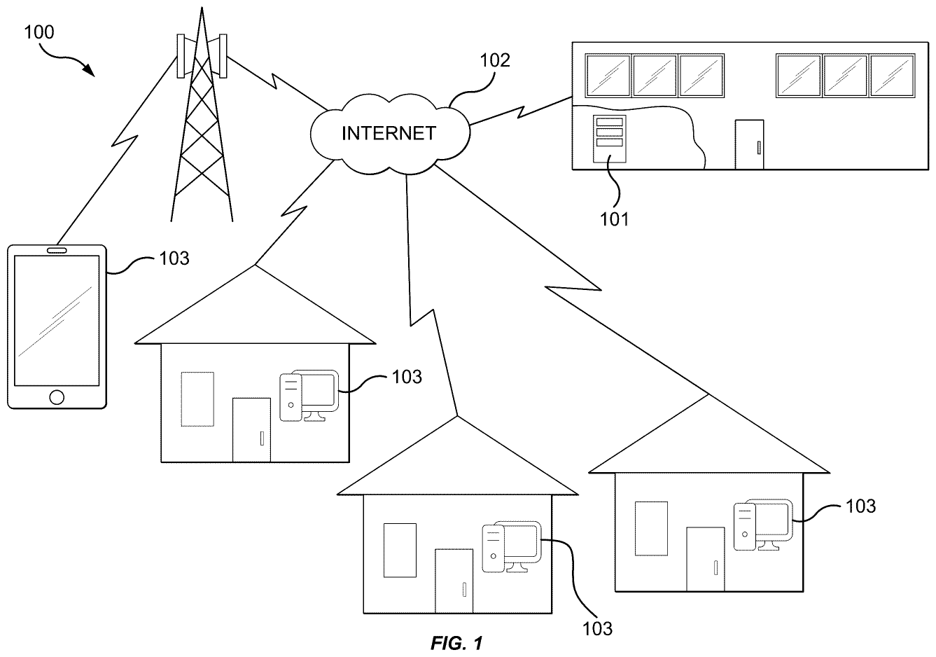

Referring to FIG. 1, the method of the present invention 100 employs a central server system 101, which communicates the game app through the Internet 102 with multiple electronic devices 103 operated by multiple game players.

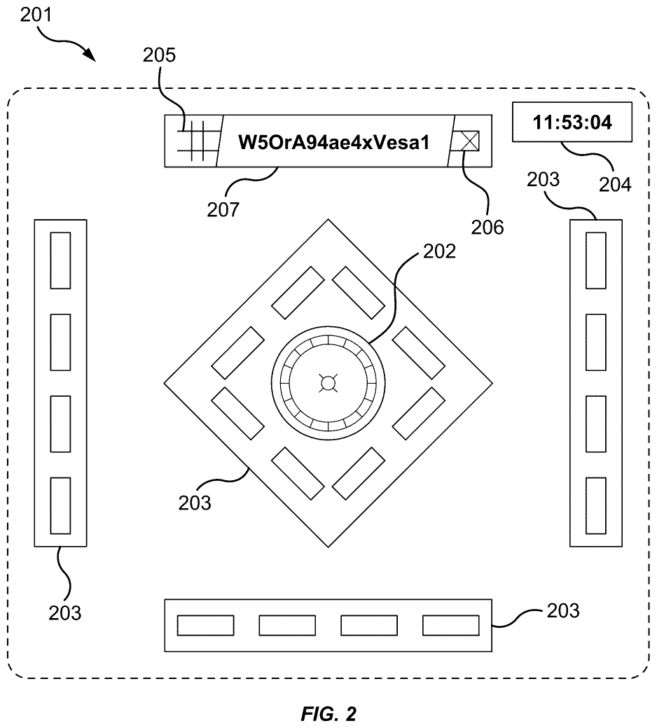

Referring to FIG. 2, the central server system 101 outputs to the players' electronic devices 103 a virtual game room display 201, representing a virtual roulette wheel 202, multiple virtual betting tables 203, a digital countdown clock 204, and an outcome display 205. The countdown clock 204 digitally displays the current Coordinated Universal Time (UTC) established by the National Institute of Standards and Technology (NIST), based on an atomic clock.

In this embodiment of the present invention 100, the countdown clock 204 counts down, with atomic clock accuracy, successive time intervals of 30 seconds. At the end of each of these time intervals, a random number is generated by a True Random Number Generator (TRNG). This true random number, or a number derived from it by way of an algorithm, is then graphically depicted on the virtual roulette wheel 202 and shown on the outcome display 205, along with a time stamp 206 indicating the exact atomic-clock time when the true random number was generated by the TRNG.

Up to 5 seconds before the end of the clock's 204 30-second countdown, players can place bets using the virtual betting tables 203. After the outcome is displayed 205, winning bets are determined and winnings paid out. In order that the players can be satisfied that the result is fair, a verification code 207 is generated after each roulette round. This verification code 207, along with the atomic time stamp 206, enables each player to independently verify that the TRNG process has been operated up to the standard of “provably fair.”

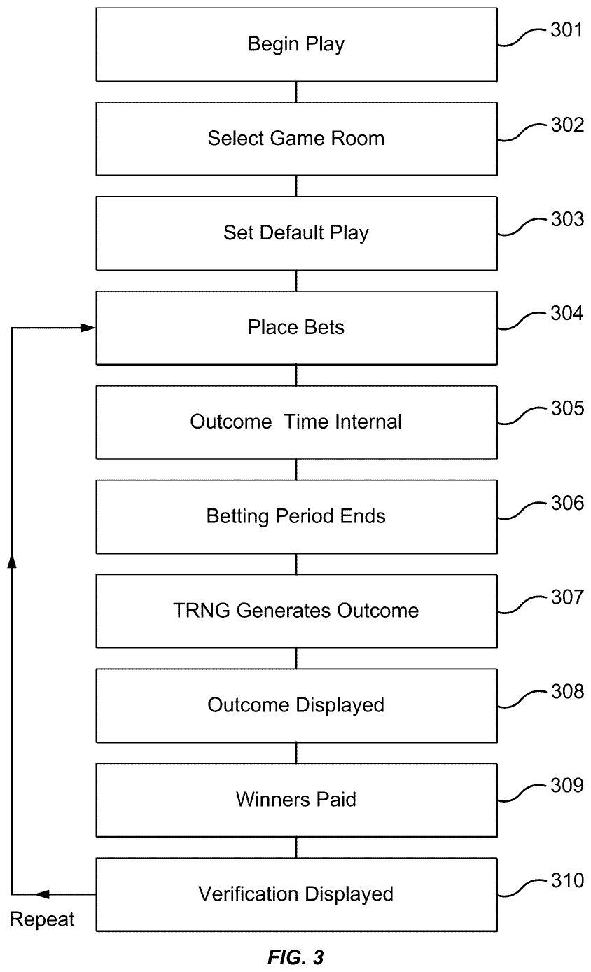

Referring now to FIG. 3, after the Atomic Roulette Game begins 301, each player can select from one of multiple “game rooms” 302, each of which replicates the displays and operations set forth in FIG. 2, but with each game room's outcomes based on its own independently generated true random numbers. Each player sets Default Play Settings 303. “Default” Selection are from the outside fields (Black, Red, Even, Odd, 1-18, 19-36), and “Amount.” This is the automatic minimum play for each round. This means that if they do not pick any additional numbers or fields on the betting table 203, this will be the Automatic Play for the round. After bets are placed 304, the atomic countdown clock 204 is ticking down from :30 to :00 after every XX:XX:00 or XX:XX:30 305. When the countdown clock 204 gets down to :05 (meaning it is at either XX:XX:25 or XX:XX:55), the betting table 203 goes dull and “No More Bets” 306 are able to be made by the player. At this time, the TRNG determines an outcome 307 and the Virtual Roulette Wheel spins to show the outcome. The outcome is displayed 308 at every XX:XX:00 or XX:XX:30 on the Atomic Clock.

After the winners are paid 309, the verification code is displayed 310, and the process reverts to the next round of roulette 304.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A method of playing a virtual roulette game, comprising the following steps:
(a) providing a central server system, wherein the central server system hosts an executable instruction set for playing the virtual roulette game, and wherein the central server system communicates through the Internet with one or more user electronic devices of one or more players;
(b) causing the central server system to output to the one or more user electronic devices, through a graphical user interface of each of the one or more user electronic devices, a virtual game room display, representing a virtual roulette wheel, one or more virtual betting tables, a digital countdown clock, and an outcome display;
(c) causing the countdown clock to digitally display a current coordinated Universal Time (UTC) as established by the National Institute of Standards and Technology (NIST), based on an atomic clock;
(d) causing the virtual roulette wheel to display a series of rounds of numerical outcomes at outcome time intervals according to the countdown clock, wherein each of the numerical outcomes is independently generated based on a True Random Number Generator (TRNG);
(e) causing the virtual betting table to accept bets from any of the one or more players who are betting players, during a betting period within each of the outcome time intervals;
(f) for each round of numerical outcomes, displaying the numerical outcome on the outcome display, determining any winning bets, and awarding payouts to any of the betting players who have placed the winning bets;
(g) for each round of numerical outcomes, displaying a result verification code on the outcome display along with a UTC time stamp, wherein the result verification code and the UTC time stamp enable any of the betting players to independently verify that the numerical outcome was generated by the TRNG, without manipulation, at a time indicated by the UTC time stamp.

2. The method according to claim 1, wherein in step (e), the betting period is closed at a bet closing time at an end of the betting period within each of the outcome time intervals.

3. The method according to claim 2, wherein in step (g), the result verification code for each round of numerical outcomes consists of a server seed and a client seed, which are hashed codes.

4. The method according to claim 2, wherein in step (d), the TRNG derives its randomness from a physical source of entropy, which is either quantum noise, thermal noise or atmospheric noise.

5. The method according to claim 3, wherein in step (d), the TRNG derives its randomness from a physical source of entropy, which is either quantum noise, thermal noise or atmospheric noise.

6. The method according to claim 4, wherein the physical source of entropy is atomic-level or quantum phenomena.

7. The method according to claim 5, wherein the physical source of entropy is atomic-level or quantum phenomena.

8. The method according to claim 4, wherein each of the one or more players can select from one of multiple virtual game rooms, each of which has an independent game room display replicating steps (a) through (g).

9. The method according to claim 8, wherein any of the one or more players can become a live player by activating a live video feed of the live player playing the virtual roulette game, wherein the live feed can be viewed by any of the one or more players who are invited by the live player.

10. The method according to claim 8, where the one or more players can chat among themselves in the same virtual game room.
